(19) United States
(12) Patent Application Publication
(10) Pub. No.: US 2026/0332997 A1
(43) Pub. Date: Oct. 22, 2026

(54) COMPACT COMPOSITE RESOURCES

(71) Applicant: Telefonaktiebolaget LM Ericsson (publ), Stockholm (SE)

(72) Inventors: Ari KERÄNEN, Helsinki (FI); Lorenzo CORNEO, Helsinki (FI); Rajat KANDOI, Espoo (FI); Jaime JIMÉNEZ, Espoo (FI)

(21) Appl. No.: 19/117,470

(22) PCT Filed: Dec. 30, 2022
(86) PCT No.: PCT/SE2022/051257

§ 371 Date: Apr. 1, 2025

Related U.S. Application Data
(60) Provisional application No. 63/412,775, filed on Oct. 3, 2022.

(51) Int. Cl. H04W 4/38; H04W 4/70; H04W 8/00

(52) U.S. Cl. CPC H04W 4/38; H04W 4/70; H04W 8/005

(57) ABSTRACT

A network node configured to communicate with a wireless device (WD), using at least one of a wired connection and a wireless connection, is described. The network node includes processing circuitry configured to determine a compact composite (CC) object associated with a resource model, where the determined CC object is to be implemented by the WD and comprises at least one of a structure description resource and a compact data resource. The structure description resource includes one or more links to one or more resources accessible by the network node, and the compact data resource includes one or more data values associated with the one or more resources. The processing circuitry is further configured to perform at least one action to collect information associated with at least one of the CC object, the structure description resource, and the compact data resource.

### TECHNICAL FIELD

The present disclosure relates to wireless communications, and in particular, to machine-to-machine communications such as lightweight machine-to-machine communication and associated object-and-resource models.

### BACKGROUND

The Third Generation Partnership Project (3GPP) has developed and is developing standards for Fourth Generation (4G) (also referred to as Long Term Evolution (LTE)), Fifth Generation (5G) (also referred to as New Radio (NR)), and Sixth Generation (6G) wireless communication systems. Such systems provide, among other features, broadband communication between network nodes (NNs), such as base stations, and mobile wireless devices (WD) such as user equipment (UE), as well as communication between network nodes and between WDs (e.g., machine-to-machine (M2M) communication).

Further, the Open Mobile Alliance (OMA) has developed and is developing specifications and/or other technical documentation for the wireless communication industry, such as the OMA Lightweight M2M (LwM2M) Object and Resource model. The OMA LwM2M Object and Resource model represents information on devices using a set of Resources grouped together in Objects. Each Resource is an atomic value of interest, such as “current temperature” or “minimum observed temperature” for an Object representing information from a temperature sensor. The resources have basic data types (e.g., integer, Boolean value, string) without complex sub-structure.

Objects are standardized in OMA, where each Object may get a unique ID number that can be used across implementations using the standard (e.g., “3303” for an IPSO Temperature Object). Also, each Resource has an ID: either IDs that are unique in the context of the Object, or in case of re-usable resources, IDs that are globally unique and registered in the same registry as the Object IDs (e.g., “5700” for “Sensor Value” of a sensor object). There may be also multiple instances of Objects and Resources in the Objects, which may be assigned Instance IDs (usually a running index, starting from zero) when the Objects are created.

The LwM2M protocol can be used to create, read, update, and delete such Objects on a LwM2M client. The Object model can also be used by other protocols and systems. The Object, Resource, and Instance IDs are used to refer to specific parts of the Objects to read and write values. The protocol (e.g., LwM2M) can use a Read operation with the Resource IDs to retrieve a single resource value, or with the Object IDs to retrieve all the resources of an Object at once. The LwM2M protocol also supports “Read Composite” method to read a selected set of resources in an, or across many, Objects. When multiple resources are read at the same time, they are represented with one of the structured standardized data formats used by LwM2M (sensor measurement list (SenML) JavaScript Object Notation (JSON), type length value (TLV), Concise Binary Object Representation (CBOR), SenML CBOR). These formats present the data using a combination of the Object, Resource, and Instance IDs (e.g., “/3303/0/5700” for Current Value of Temperature Object instance 0) and the resource value itself (e.g., “42”). For example, in SenML JSON notation Current Value of Temperature Object may be [{“n”:“/3303/0/5700”, “v”:42}].

Further, the LwM2M protocol uses two mechanisms to link information elements: the Object Link and the Constrained RESTful Environments (CORE) Link Format. The Object Link is a link used to refer to an Instance of a given Object, on the same client, in the form of “ObjectID: InstanceID”. CORE Link describes relations between constrained application protocol (CoAP) resources which can be in the form of relative or absolute uniform resource locators (URLs). Relative URLs in LwM2M usage may refer to LwM2M Objects and Resources on the same device. For example, in the case of LwM2M, a link “</3303/0/5700>” would point to the current value Resource of a temperature sensor Object as discussed above.

Object Links can be used to create LwM2M Composite Objects, which are Objects created from existing objects by using Object Link resources that point to different Object instances. For example, a Thermostat Object could link to Temperature, Setpoint, and Actuation Objects. In this case the new Composite Object structure is fixed at the design time and only full Objects are used in composition.

The structured formats (SenML, etc.) used by the LwM2M for Object serialization allow for implementations to handle data with multiple resource values, but they can also create substantial overhead for the transfer of the data since the identifiers (IDs) of the Objects and Resources are included in the format.

In some use cases multiple different values are sent together. Examples include smart metering (e.g., current value and an average value) and geolocation (latitude, longitude, and altitude values).

One way to solve the problem of efficiently combining multiple data elements to a single resource would be to define and standardize new Resources that contains all the needed values in a single Resource, e.g., in an array structure. However, the approach of simply packing multiple data values to a single resource has multiple downsides such as:
The resource format becomes specific to that usage. A specific parser for the resource is needed (e.g., program reading array of data would need specific knowledge to tell which array item has what meaning).
There is no possibility to describe the details of the embedded data items, e.g., their type, unit, min/max values, etc. that have standard attributes in the Resource description format of the LwM2M Objects.
The values in a packed format cannot be operated independently: a single value embedded in a resource cannot be read and/or changed. Changes to a single value (common usage pattern with LwM2M) cannot be observed (e.g., determined).

### SUMMARY

Some embodiments advantageously provide methods, systems, and apparatuses for determining compact composite resources. Some other embodiments provide methods, systems, and apparatuses for machine-to-machine communications such as lightweight machine-to-machine communication and associated object-and-resource models. In some embodiments, the LwM2M Object model and protocol is extended to allow complex, composite data types to support use cases where multiple different values are sent together.

In one or more embodiments, a method of describing a structure and semantics of a resource, such as a structured LwM2M resource, in terms of other resources is described. Links to the resources and additional information on how the values in the resources are mapped to a new structured resource may be used.

In some embodiments, an object such as a “Compact Composite” LwM2M Object is introduced with two key resources:
1) “Structure description” Resource (i.e., set of links to Resources in Objects hosted by the device)
2) a Resource that contains the result of combining the values of these resources into a single compact structure, as described in the description

In some other embodiments, the Compact Composite (CC) Object links to resources of existing Object definitions, which may help retaining the capabilities of more granular access and semantics of separate resources (since when needed, the original Resources can be discovered from the CC Object links).

In an embodiment, LwM2M Management Server (MS) can create Compact Composite Objects for the sets of resources it needs to access using the compact structure format. The MS can also discover existing Compact Composite objects. By examining the link resources, the structure of the combination resource may be determined (e.g., fully determined) such as without additional specific knowledge of the Object. In another embodiment, (e.g., instead of the Object dedicated for this information), the structure description format may be used in an existing Object, as a Resource or metadata, to describe one or more of the Resources of the Object, i.e.,

“Inline Description.”

In another embodiment, a method for a LwM2M object model is described. The method and/or the LwM2M object model may be used for collecting a set of resources to a structured Resource, e.g., while retaining the original semantics and capabilities of separate resources.

In some embodiments, a combination of CORE link format pointers may be used such as: 1) JSON Pointer/Path statements or XPath statements; or 2) JSON/XML Templates. The combination of CoRE link format pointers may be used to describe how the data elements is to be structured in a Resource.

One or more embodiments enable the combination of well-structured and granular semantics of the LwM2M Object model with an alternative representation of the combination of resources to a compact, structured set. Further, one or more embodiments enable keeping the existing capabilities of the LwM2M Object model and protocol for interacting with atomic parts of data and describing their semantics in detail, e.g., while providing an additional, configurable, representations of those resources when a software application requests (e.g., needs) them.

Some embodiments provide reduction of overhead associated with transferring multiple resource values at once and provide a method for combining multiple separate, but related, resources into one resource. A more compact representation may reduce the transfer time and, especially for wireless sensors, reduce energy consumption. Compact data representations are particularly beneficial for sensors that are difficult to physically access (e.g., sensors built within concrete) and to replace the battery.

According to an aspect, a network node configured to communicate with a wireless device (WD), using at least one of a wired connection and a wireless connection, is described. The network node comprises processing circuitry configured to determine a compact composite (CC) object associated with a resource model, where the determined CC object is to be implemented by the WD and comprises at least one of a structure description resource and a compact data resource. The structure description resource comprises one or more links to one or more resources accessible by the network node, and the compact data resource includes one or more data values associated with the one or more resources. The processing circuitry is further configured to perform at least one action to collect information associated with at least one of the CC object, the structure description resource, and the compact data resource.

In some embodiments, the determination of the CC object includes creating the CC object, where the creation of the CC object includes transmission of a first request to create the CC object that triggers the WD to implement the CC object.

In some other embodiments, the determination of the CC object includes discovering the CC object at least by sending a second request to read the one or more links.

In an embodiment, the determination of the CC object includes examining the one or more links to determine a structure of the compact data resource and to perform the at least one action to collect the information based on the determined structure.

In another embodiment, the performing of the at least one action includes causing transmission of a third request to create or discover another CC object based on the examination of the one or more links.

In some embodiments, the CC object is pre-instantiated in the WD.

In some other embodiments, the processing circuitry is further configured to: at least one of receive a data request from a software application to provide data associated with one CC object and receive a CC object identifier from the WD; and determine the CC object based on at least one of the received data request and the received CC object identifier.

In an embodiment, the processing circuitry is further configured to cause transmission a fourth request to one of create and update the compact data resource using a composite read operation. The fourth request includes an indication indicating whether the compact data resource is to be created or updated.

In another embodiment, the one or more links points to at least one of an array of the data values and a map of the data values.

In some embodiments, at least one of: the information includes the one or more data values associated with the one or more resources; the resource model is a lightweight machine to machine (LwM2M) object resource model; the CC object is a CC LwM2M object; the network node is an LwM2M management server; and the WD is an LwM2M client.

According to another aspect, a method in a network node configured to communicate with a wireless device (WD), using at least one of a wired connection and a wireless connection, is described. The method comprises determining a compact composite (CC) object associated with a resource model, where the determined CC object is to be implemented by the WD and comprises at least one of a structure description resource and a compact data resource. The structure description resource comprising one or more links to one or more resources accessible by the network node, and the compact data resource includes one or more data values associated with the one or more resources. The method further includes performing at least one action to collect information associated with at least one of the CC object, the structure description resource, and the compact data resource.

In some embodiments, the determination of the CC object includes creating the CC object. The creation of the CC object includes transmission of a first request to create the CC object that triggers the WD to implement the CC object.

In some other embodiments, the determination of the CC object includes discovering the CC object at least by sending a second request to read the one or more links.

In an embodiment, the determination of the CC object includes examining the one or more links to determine a structure of the compact data resource and to perform the at least one action to collect the information based on the determined structure.

In another embodiment, the performing of the at least one action includes causing transmission of a third request to create or discover another CC object based on the examination of the one or more links.

In some embodiments, the CC object is pre-instantiated in the WD.

In some other embodiments, the method further includes at least one of: receiving a data request from a software application to provide data associated with one CC object and receiving a CC object identifier from the WD; and determining the CC object based on at least one of the received data request and the received CC object identifier.

In an embodiment, the method further includes transmitting a fourth request to one of create and update the compact data resource using a composite read operation, where the fourth request includes an indication indicating whether the compact data resource is to be created or updated.

In another embodiment, the one or more links points to at least one of an array of the data values and a map of the data values.

In some embodiments, at least one of: the information includes the one or more data values associated with the one or more resources; the resource model is a lightweight machine to machine (LwM2M) object resource model; the CC object is a CC LwM2M object; the network node is an LwM2M management server; and the WD is an LwM2M client.

According to one aspect, a wireless device (WD) configured to communicate with a network node using at least one of a wired connection and a wireless connection is described. The WD comprises processing circuitry configured to determine a compact composite (CC) object associated with a resource model. The determined CC object to be implemented by the WD and comprising at least one of a structure description resource and a compact data resource. The structure description resource comprises one or more links to one or more resources accessible by the network node, the compact data resource including one or more data values associated with the one or more resources. The processing circuitry is further configured to perform at least one action to provide information associated with at least one of the CC object, the structure description resource, and the compact structure resource.

In some embodiments, the determination of the CC object includes creating the CC object based on a first request received form the network node.

In some other embodiments, the determination of the CC object includes making the CC object discoverable by the network node based on a second request, received from the network node, to read the one or more links.

In an embodiment, the provided information triggers the network node to examine the one or more links to determine a structure of the compact data resource.

In another embodiment, the processing circuitry is further configured to receive a third request to create or discover another CC object based on the examination of the one or more links.

In some embodiments, the CC object is pre-instantiated in the WD.

In some other embodiments, the processing circuitry is further configured to cause transmission of a CC object identifier usable by the network node to determine the CC object.

In an embodiment, the processing circuitry is further configured to receive a fourth request to one of create and update the compact data resource using a composite read operation. The fourth request includes an indication indicating whether the compact data resource is to be created or updated.

In another embodiment, the one or more links points to at least one of an array of the data values and a map of the data values.

In some embodiments, at least one of: the information includes the one or more data values associated with the one or more resources; the resource model is a lightweight machine to machine (LwM2M) object resource model; the CC object is a CC LwM2M object; the network node is an LwM2M management server; and the WD is an LwM2M client.

According to another aspect, the method in a wireless device (WD) configured to communicate with a network node using at least one of a wired connection and a wireless connection is described. The method comprises determining a compact composite (CC) object associated with a resource model, where the determined CC object is to be implemented by the WD and comprises at least one of a structure description resource and a compact data resource. The structure description resource comprises one or more links to one or more resources accessible by the network node, and the compact data resource includes one or more data values associated with the one or more resources. At least one action is performed to provide information associated with at least one of the CC object, the structure description resource, and the compact structure resource.

In some embodiments, the determination of the CC object includes creating the CC object based on a first request received form the network node.

In some other embodiments, the determination of the CC object includes making the CC object discoverable by the network node based on a second request, received from the network node, to read the one or more links.

In an embodiment, the provided information triggers the network node to examine the one or more links to determine a structure of the compact data resource.

In another embodiment, the method further includes receiving a third request to create or discover another CC object based on the examination of the one or more links.

In some embodiments, the CC object is pre-instantiated in the WD.

In some other embodiments, the method further includes transmitting a CC object identifier usable by the network node to determine the CC object.

In an embodiment, the method further includes receiving a fourth request to one of create and update the compact data resource using a composite read operation, the fourth request including an indication indicating whether the compact data resource is to be created or updated.

In another embodiment, the one or more links points to at least one of an array of the data values and a map of the data values.

In some embodiments, at least one of the information includes the one or more data values associated with the one or more resources; the resource model is a lightweight machine to machine (LwM2M) object resource model; the CC object is a CC LwM2M object; the network node is an LwM2M management server; and the WD is an LwM2M client.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node according to some embodiments of the present disclosure;

FIG. 8 is a flowchart of an example process in a wireless device according to some embodiments of the present disclosure;

FIG. 9 is a flowchart of another example process in a network node according to some embodiments of the present disclosure;

FIG. 10 is a flowchart of another example process in a wireless device according to some embodiments of the present disclosure;

FIG. 11 shows an example high-level system overview according to some embodiments of the present disclosure;

FIG. 12 shows an example sequence diagram according to some embodiments of the present disclosure;

FIG. 13 shows an example discovery of target links contents according to some embodiments of the present disclosure; and

FIG. 14 shows an example Sequence diagram for inline description according to some embodiments of the present disclosure.

### DETAILED DESCRIPTION

Before describing in detail example embodiments, it is noted that the embodiments reside primarily in combinations of apparatus components and processing steps related to determining compact composite resources. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3^{rd} party node, a node external to the current network), nodes in distributed antenna system (DAS), a spectrum access system (SAS) node, an element management system (EMS), a server (e.g., LwM2M server, LwM2M Management Server, LwM2M Bootstrap-Server), a client (e.g., LwM2M client, IoT device/gateway), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, a server (e.g., LwM2M server, LwM2M Management Server, LwM2M Bootstrap-Server), a client (e.g., LwM2M client, IoT device/gateway), etc.

In some embodiments, LwM2M Client may be a component running on a device such as a WD implementing the LwM2M protocol, e.g., for interacting with the LwM2M Server and/or a LwM2M Bootstrap-Server. LwM2M Clients may be implemented in IoT devices and gateways. LwM2M Server may be a component (e.g., NN) implementing the server-side functionality of the LwM2M protocol such as for interacting with an LwM2M Client. The LwM2M Server software (i.e., a software application on the NN) may be running on a non-IoT device (e.g., NN), such as an on-premises server or in a cloud-based infrastructure.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), LwM2M, may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

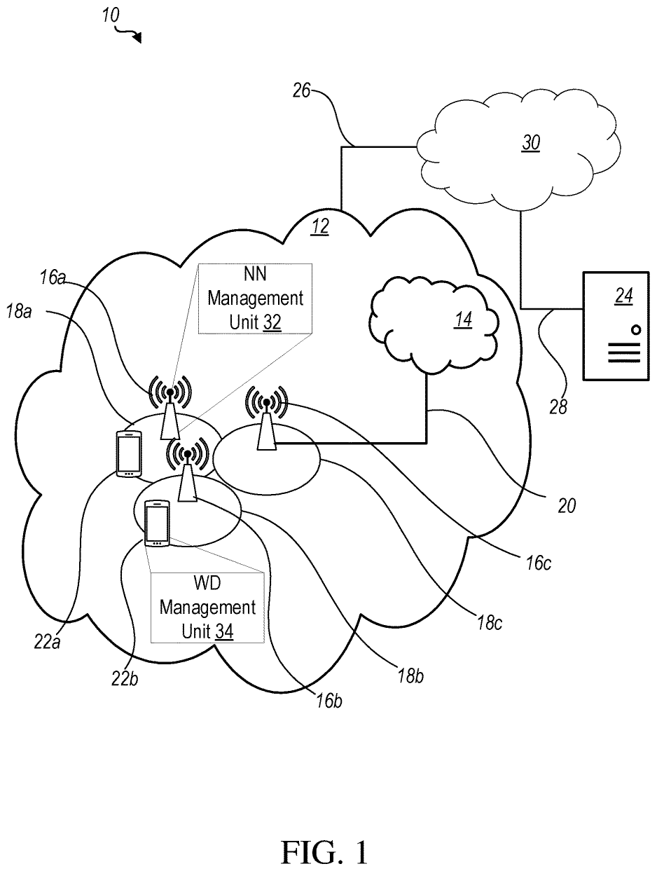

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a NN management unit 32 which is configured to perform any step and/or task and/or process and/or method and/or feature described in the present disclosure, e.g., determine a compact composite (CC) object associated with a resource model, the determined CC object to be implemented by the WD and comprising at least one of a structure description resource and a compact structure resource. A wireless device 22 is configured to include a WD management unit 34 which is configured to perform any step and/or task and/or process and/or method and/or feature described in the present disclosure, e.g., determine a compact composite (CC) object associated with a resource model, the determined CC object to be implemented by the WD and comprising at least one of a structure description resource and a compact structure resource.

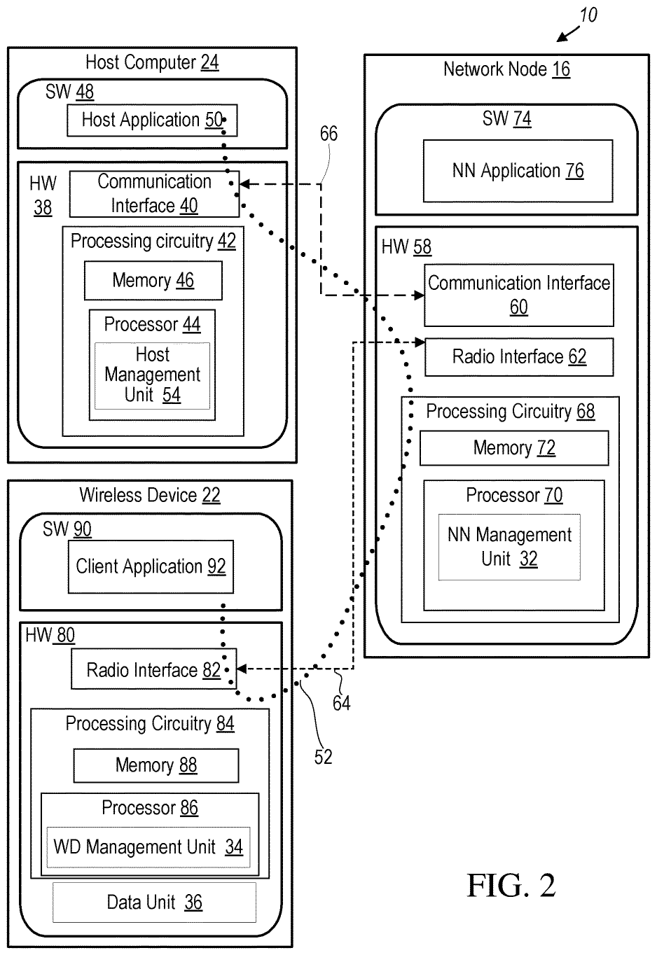

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host management unit 54 configured to enable the service provider to perform any step and/or task and/or process and/or method and/or feature described in the present disclosure, e.g., observe/monitor/control/transmit to/receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. Software 74 may comprise at least one NN application 76 (e.g., an application, software application, program, user interface such as to provide one or more functions associated with LwM2M, request/receive/display data such as temperature measured by a sensor (i.e., wireless device)). The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include NN management unit 32 which is configured to perform any step and/or task and/or process and/or method and/or feature described in the present disclosure, e.g., determine a compact composite (CC) object associated with a resource model, the determined CC object to be implemented by the WD and comprising at least one of a structure description resource and a compact structure resource.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD management unit 34 which is configured to perform any step and/or task and/or process and/or method and/or feature described in the present disclosure, e.g., determine a compact composite (CC) object associated with a resource model, the determined CC object to be implemented by the WD and comprising at least one of a structure description resource and a compact structure resource.

Hardware 80 may further include data unit 36 in communication with any of the components of WD 22. Data unit 36 may comprise a sensor (such as an internet of things (IoT) sensor, motion sensor, proximity sensor, M2M sensor, industrial sensor, pollution sensor, carbon monoxide/smoke sensor, pressure sensor, temperature sensor), camera, activity tracker, a measuring unit, location unit such as a global positioning system, etc. Data unit 36 may be configured to perform any step and/or task and/or process and/or method and/or feature described in the present disclosure, e.g., measure one or more parameters (such as temperature, pressure, location, pollution level, carbon/smoke parts per million (PPM), humidity, wind speed/direction, motion parameters, etc.) and/or provide imaging processing (such as capture images, record video, etc.) and/or provide data associated with measured parameters and/or image processing to one or more components of WD 22 and/or any other devices of communication system 10 such as NN 16, e.g., via radio interface 82.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as NN management unit 32, and WD management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

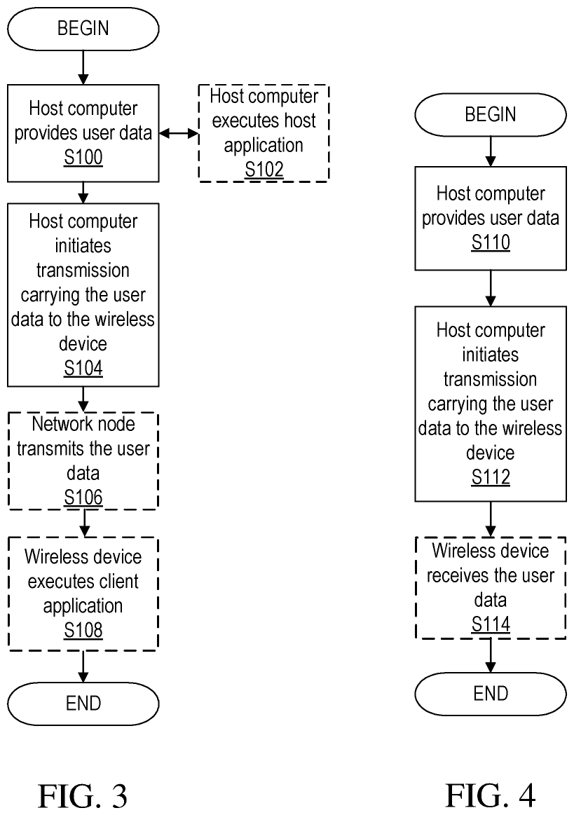

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

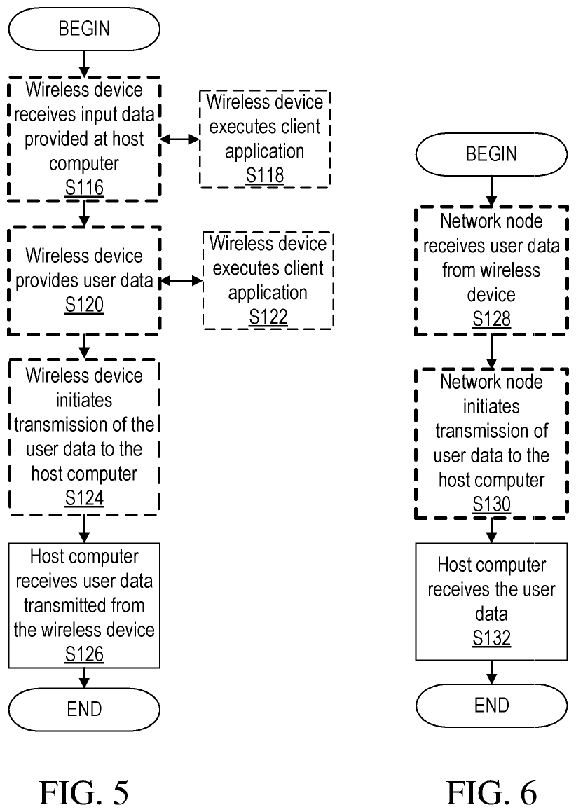

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

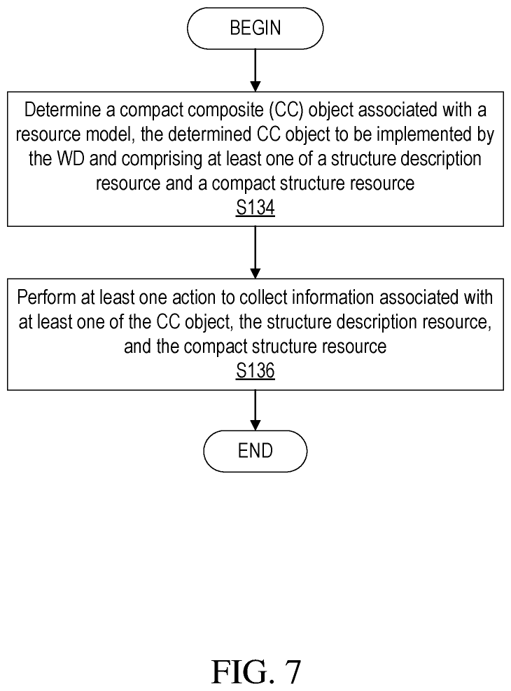

FIG. 7 is a flowchart of an example process in a network node. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to determine (Block S134) a compact composite (CC) object associated with a resource model, where the determined CC object is to be implemented by the WD 22 and comprises at least one of a structure description resource and a compact structure resource; and perform (Block S136) at least one action to collect information associated with at least one of the CC object, the structure description resource, and the compact structure resource.

In some embodiments, the CC object includes a link to one or more resources including the at least one of the structure description resource and the compact structure resource.

In some other embodiments, the determination of the CC object includes at least one of creating the CC object, where the creation of the CC object includes transmission of a first request to create the CC object that triggers the WD 22 to implement the CC object, and the set of resources are accessible to the network node 16; discovering the created CC object at least by sending a second request to read the link of the CC object; and examining the link of the CC object to determine a structure of the compact structure resource and perform the at least one action to collect the information based on the determined structure.

In an embodiment, at least one of the resource model is a lightweight machine to machine (LwM2M) object resource model; the CC object is a CC LwM2M object; the network node 16 is an LwM2M management server; and the WD 22 is an LwM2M client.

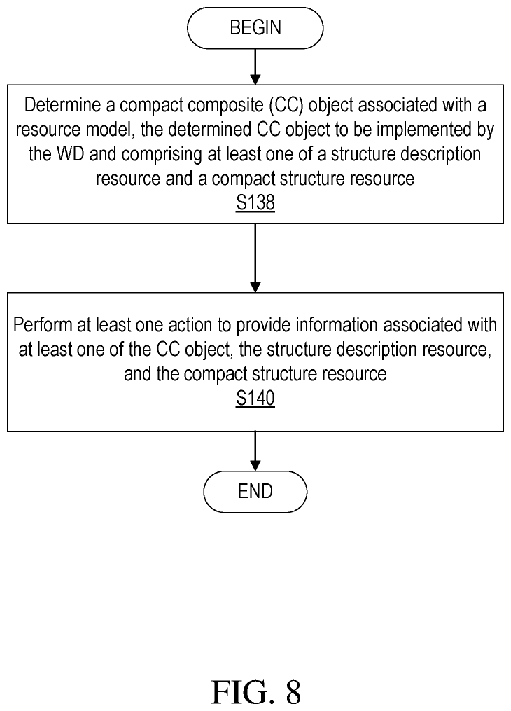

FIG. 8 is a flowchart of an example process in a wireless device 22 according to some embodiments of the present. One or more blocks described herein may be performed by one or more elements of wireless device 22 such as by one or more of processing circuitry 84 (including the WD management unit 34), data unit 36, processor 86, radio interface 82 and/or communication interface 60. Wireless device 22 such as via processing circuitry 84 and/or processor 86 and/or radio interface 82 is configured to determine (Block S138) a compact composite (CC) object associated with a resource model, where the determined CC object is to be implemented by the WD 22 and comprises at least one of a structure description resource and a compact structure resource; and perform (Block S140) at least one action to provide information associated with at least one of the CC object, the structure description resource, and the compact structure resource.

In some embodiments, the CC object includes a link to one or more resources including the at least one of the structure description resource and the compact structure resource.

In some other embodiments, the determination of the CC object includes at least one of: creating the CC object for a set of resources, where the created CC object is implemented by the WD based on a first request by the network node 16, and the set of resources is accessible to the network node 16; and receiving a second request to read the link of the CC object, where the received request allows the network node 16 to discover the created CC object. The discovering of the created object is usable by the network node 16 to examine the link of the CC object to determine a structure of the compact structure resource and perform the at least one action to collect the information.

In an embodiment, at least one of the resource model is a lightweight machine to machine (LwM2M) object resource model; the CC object is a CC LwM2M object; the network node 16 is an LwM2M management server; and the WD 22 is an LwM2M client.

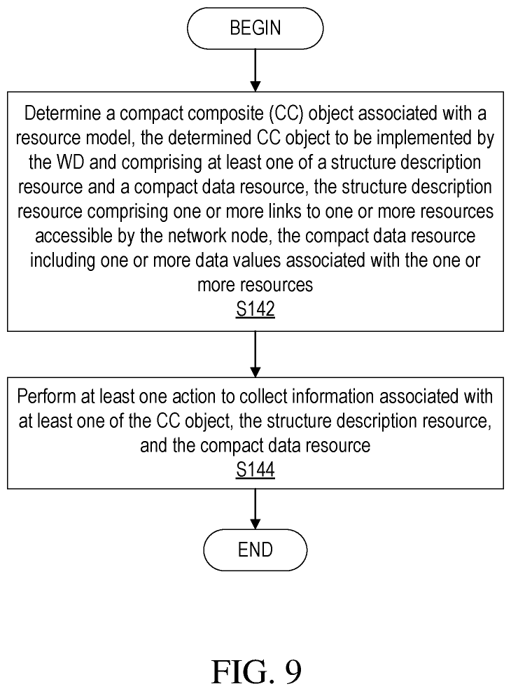

FIG. 9 is a flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to determine (Block 142) a compact composite (CC) object associated with a resource model. The determined CC object is to be implemented by the WD 22 and comprises at least one of a structure description resource and a compact data resource. The structure description resource comprises one or more links to one or more resources accessible by the network node 16. The compact data resource includes one or more data values associated with the one or more resources. Network node 16 is further configured to perform (Block S144) perform at least one action to collect information associated with at least one of the CC object, the structure description resource, and the compact data resource.

In some embodiments, the determination of the CC object includes creating the CC object. The creation of the CC object includes transmission of a first request to create the CC object that triggers the WD 22 to implement the CC object.

In some other embodiments, the determination of the CC object includes discovering the CC object at least by sending a second request to read the one or more links.

In an embodiment, the determination of the CC object includes examining the one or more links to determine a structure of the compact data resource and to perform the at least one action to collect the information based on the determined structure.

In another embodiment, the performing of the at least one action includes causing transmission of a third request to create or discover another CC object based on the examination of the one or more links.

In some embodiments, the CC object is pre-instantiated in the WD 22.

In some other embodiments, the method further includes at least one of: receiving a data request from a software application to provide data associated with one CC object and receiving a CC object identifier from the WD 22; and determining the CC object based on at least one of the received data request and the received CC object identifier.

In an embodiment, the method further includes transmitting a fourth request to one of create and update the compact data resource using a composite read operation, where the fourth request includes an indication indicating whether the compact data resource is to be created or updated.

In another embodiment, the one or more links points to at least one of an array of the data values and a map of the data values.

In some embodiments, at least one of: the information includes the one or more data values associated with the one or more resources; the resource model is a lightweight machine to machine (LwM2M) object resource model; the CC object is a CC LwM2M object; the network node 16 is an LwM2M management server; and the WD is an LwM2M client.

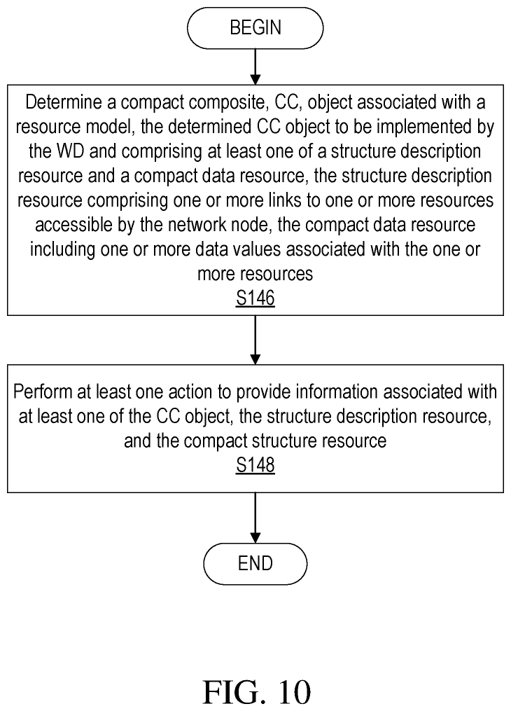

FIG. 10 is a flowchart of an example process in a wireless device 22 according to some embodiments of the present. One or more blocks described herein may be performed by one or more elements of wireless device 22 such as by one or more of processing circuitry 84 (including the WD management unit 34), data unit 36, processor 86, radio interface 82 and/or communication interface 60. Wireless device 22 such as via processing circuitry 84 and/or processor 86 and/or radio interface 82 is configured to determine (Block S146) a compact composite (CC) object associated with a resource model, where the determined CC object is to be implemented by the WD 22 and comprises at least one of a structure description resource and a compact data resource. The structure description resource comprises one or more links to one or more resources accessible by the network node 16. The compact data resource includes one or more data values associated with the one or more resources. Wireless device 22 is further configured to perform (Block S148) at least one action to provide information associated with at least one of the CC object, the structure description resource, and the compact structure resource.

In some embodiments, the determination of the CC object includes creating the CC object based on a first request received form the network node 16.

In some other embodiments, the determination of the CC object includes making the CC object discoverable by the network node 16 based on a second request, received from the network node 16, to read the one or more links.

In an embodiment, the provided information triggers the network node 16 to examine the one or more links to determine a structure of the compact data resource.

In another embodiment, the method further includes receiving a third request to create or discover another CC object based on the examination of the one or more links.

In some embodiments, the CC object is pre-instantiated in the WD 22.

In some other embodiments, the method further includes transmitting a CC object identifier usable by the network node 16 to determine the CC object.

In an embodiment, the method further includes receiving a fourth request to one of create and update the compact data resource using a composite read operation, the fourth request including an indication indicating whether the compact data resource is to be created or updated.

In another embodiment, the one or more links points to at least one of an array of the data values and a map of the data values.

In some embodiments, at least one of the information includes the one or more data values associated with the one or more resources; the resource model is a lightweight machine to machine (LwM2M) object resource model; the CC object is a CC LwM2M object; the network node 16 is an LwM2M management server; and the WD is an LwM2M client.

Having described the general process flow of arrangements of the disclosure and having provided examples of hardware and software arrangements for implementing the processes and functions of the disclosure, the sections below provide details and examples of arrangements for determining compact composite resources.

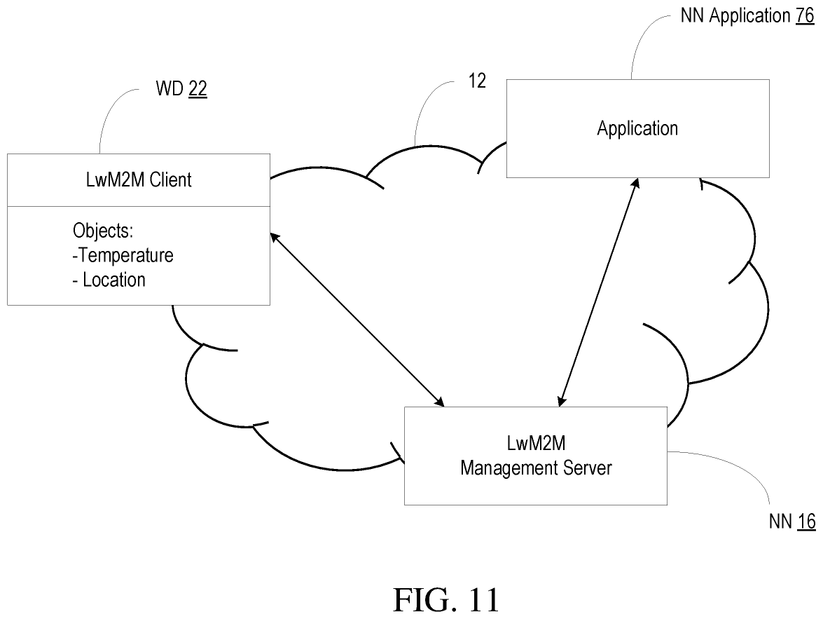

FIG. 11 shows a high-level system overview of NN 16 (e.g., LwM2M management server (MS)), WD 22 (e.g., LwM2M client), and NN application 76 (e.g., application) interacting. Note that NN application 76 may be comprised in NN 16 or another NN 16 or any other device/node of communication system 10. Further, although WD 22 and NN 16 are shown as comprising the LwM2M MS and LwM2M client, respectively, the present disclosure is not limited as such, i.e., LwM2M MS and L2M2M client may be comprised in any component of communication system 10.

In some embodiments, one or more key extensions relevant to the present disclosure reside in the WD 22 (e.g., LwM2M client) and NN 16 (e.g., LwM2M server) that are able to fulfill application requests more efficiently than via other arrangements. The WD 22 (e.g., LwM2M client) may be configured to implement (e.g., perform one or more steps associated with) a set of standardized objects (e.g., “Temperature” and “Location”) based on the capabilities it has (e.g., a temperature sensor and a GPS receiver).

When Compact Composite (CC) Object embodiment is used, NN (e.g., the LwM2M MS) may discover whether the WD 22 (e.g., LwM2M client) implements one or more embodiments of the present disclosure by discovering (e.g., using either registration or discovery methods, etc.) existing CC Object instances on WD 22 (e.g., LwM2M client). If WD 22 (e.g., LwM2M client) does not currently implement any CC Objects, the NN 16 (e.g., LwM2M server) may create (e.g., attempt to create, request to create) a new instance of a CC Object. A WD 22 (e.g., LwM2M client) that supports the CC functionality may accept the request to create. A WD 22 (e.g., LwM2M client) that does not support the CC functionality may return an error at this step.

When “Inline description” (i.e., in the same Object that hosts the target resources used in the resulting structured data) is used, the client NN 16 (e.g., LwM2M MS) can detect support from a new Object Schema version (e.g., if description is part of the schema such as a new attribute of a Resource) or existence of a TargetLinks resource (see Section “CompactData Re-usable Resource”).

NN application 76 (e.g., Application) may send one or more requests to the NN 16 (e.g., LwM2M MS) for information that the WD 22 (e.g., LwM2M client) has (e.g., sensor data provided by data unit 36). The NN 16 (e.g., LwM2M MS) may translate the request to the best available LwM2M protocol and object model method, e.g., using the CC Object Resources if such are available. The CC Object may include at least following two resources:
TargetLinks (readable and writable, multi-instance resource, with CORE link data type) which may include a CoRE Link to a resource instance to be stored in a CompactData array. Each link resource instance may result in a new item in the CompactData array. Instance identifiers (IDs) of the Links may correspond to the array index of the resulting array.
   In one embodiment, the resource is single-instance, and the order of the links in a (CoRE Link standard) comma-separated link list is used to determine the array indexes. In another embodiment, additional attributes can be used to determine the array index or other location (see Section “Expressive and efficient data structures”). The first embodiment with separate Instance IDs may give more granular control over the links with LwM2M protocol (e.g., easily create, update, and remove individual links) and/or the additional attributes give more control over the resulting compact data structure.
   The links may point to other resources in the same Object instance. It may be also possible to link to Resources in other Objects.
CompactData (e.g., readable and writable, single-instance resource, with opaque (byte string) data type) which may include a CBOR Array of resources compacted in the same order as links in Target Links resource.
   In one embodiment, the data may comprise JSON, Extensible Markup Language (XML), Efficient XML Interchange (EXI) (compressed XML), and/or other structured format that supports representing at least a list of items (e.g., CSV (comma separated values), or TLV (type-length-value) items)

The CC Object may also include additional resources with information about the use of this Object, such as:
Description (e.g., readable and writable, single-instance resource, with string data type): Human-readable description of the purpose and intended use of this Compact Composite Object instance

The TargetLinks resource may be used to discover the contents of the CompactData resource and/or to configure the CC Object instance to include certain resource values in the CompactData resource. The CompactData resource is an array of values, one array item per link in the TargetLinks.

It is noted that, in one or more embodiments, matching the instance IDs of the TargetLinks resources with array indexes in the CompactData array is described. This enables to use sparse arrays as a result (e.g., to be able to add more values later without changing the array index of the values). If sparse arrays are not desirable, other embodiment could include the resource values in the array in the order of the instance IDs but leaving no gaps in between even if instance IDs are not consecutive

### CompactData Re-usable Resource

In one embodiment, a CompactData Re-usable Resource can be defined and/or be embedded in any other Object as a new Resource (e.g., instead of providing CompactData in a new Object). In this case, the TargetLinks may hold a static value and defined at design time as a static Re-usable Resource or alternatively as metadata in the Object definition. Existing Objects may be updated and/or new Objects defined. In some cases, Compact Composite Object is not used. Further, CompactData may be a multi-instance resource to support multiple ways to compact the data in the enclosing Object (e.g., one Instance combines Current, Min (i.e., minimum), and Max (i.e., maximum) temperature and another Min, Max, and Average, and/or adds resources from other Objects).

In another embodiment, other methods (e.g., other than a method using Re-usable Resource) may be performed to designate one or more of the Resources of an Object to hold the contents of the CompactData and/or TargetLinks. These include new standardized data types for this purpose, metadata in the schema, or metadata as LwM2M attribute.

### Efficient Link Set Representations

In some embodiments, since the CORE link format is a relatively verbose format, another implementation (e.g., constrained implementation) may provide more compact implementation for the TargetLinks sets. Representing Link values as CBOR arrays with each array entry containing Object, Resource or Instance IDs is one option. Further compression can be obtained with delta-encoding of the IDs, i.e., expressing only the difference from the previous ID in the array.

Even further compression can be obtained with a new format and resource that enables to represent registered link sets with a shorthand. In this case, a new registry is created and if a set of links for an application or use case is common, such set can be registered in the registry and given a single, unique ID value. Such registry could be hosted by a standardization organization, such as OMA, or it could be application specific, or combination of both (with appropriate namespace considerations). NN Application 76 (e.g., Applications) that are aware of this value can use it as a shorthand for a full Link Set. For example, assuming set of three links (Temperature Object Sensor Value and Min/Max values, represented here in CoRE link format):
</3303/0/5700>,</3303/0/5601>,</3303/0/5602>

This set could be registered and given a new ID, e.g., “set42”. If this method is supported by the WD 22 (e.g., LwM2M client), a new resource, “RegisteredTargetLinks” can host this value. When a known value is written to the resource, the resulting registered set is written by the WD 22 (e.g., LwM2M client), to the TargetLinks resource (for discovery by implementations that do not support the shorthand) and CompactData is updated accordingly. The NN 16 (e.g., LwM2M MS) can read this resource instead of the TargetLinks resource to save on transferred data.

### Expressive and Efficient Data Structures

One or more features of the embodiments are designed for applications or use cases that need access to multiple resources and require efficient (compact) data transmission. One or more steps may be performed with respect to the structure of the transmitted data, e.g., so that it can be parsed correctly. Two classes of solutions (e.g., with respect to the structure of the transmitted data) are proposed 1) a JSON (or other structured data such as XML) template where CoRE links are used as placeholders for data to be added; and 2) CoRE links with JSON Paths or Pointers (or Xpath if XML is used).

Example of the JSON template may be as follows:
{“temp”: {“val”: “</3303/0/5700>”, “min”: “</3303/0/5601>”, “max”: “</3303/0/5602>”}}

The same can be expressed with JSON paths as:
</3303/0/5700>;p=/temp/val,</3303/0/5601>;p=/temp/min,</3303/0/5602>;p=/temp/max

The example described in the “Efficient Link Set representations” Section could be re-written using JSON path parameters and CoRE Links as follows:
</3303/0/5700>;p=/1,</3303/0/5601>;p=/2,</3303/0/5602>;p=/3

In this case, the parameter p=/N indicates that such resource is to be found at the N-th position in the resulting array.

Another example using JSON template that results in a compact array format may be:
[“</3303/0/5700>”, “</3303/0/5601>”, “</3303/0/5602>”]

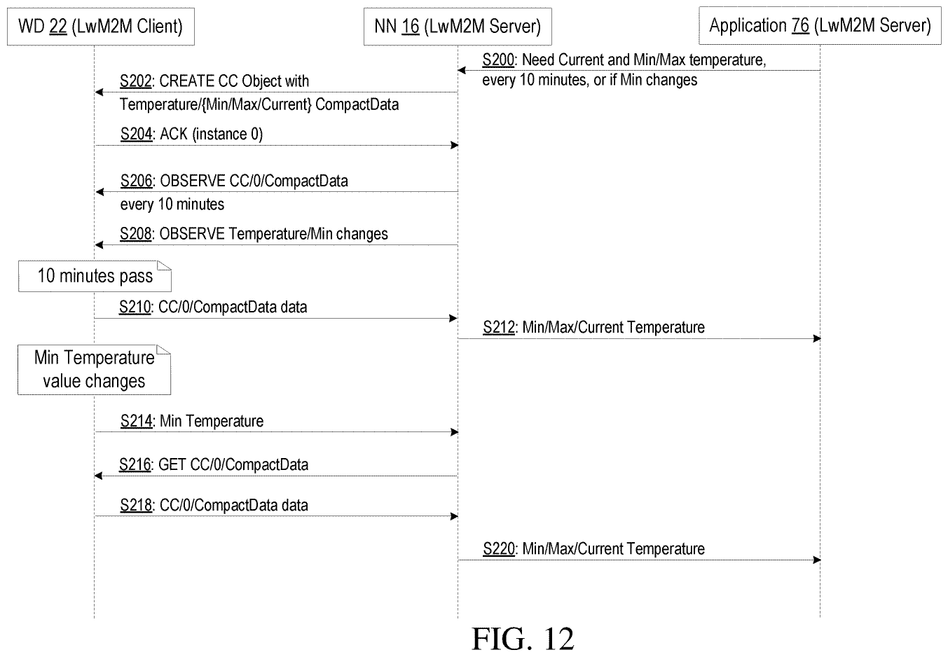

In FIG. 12, at step S200, the NN Application 76 indicates NN 16 (e.g., LwM2M MS) the kind of information it needs and when. Since the NN Application 76 requests a set of related information elements to be delivered at the same time, the NN 16 (e.g., LwM2M MS) uses the Compact Composite (CC) Object to optimize the data transfer between the NN 16 (e.g., LwM2M MS) and the WD 22 (e.g., LwM2M client).

In step 202, the NN 16 (e.g., LwM2M MS) creates a new CC object on the WD 22 (e.g., LwM2M client) with 3 links: Temperature Object's current, minimum, and maximum values.

Since the WD 22 (e.g., LwM2M client) implements this method, in step S204, the WD 22 acknowledges the creation and inform the NN 16 (e.g., LwM2M MS) that it has created a new CC Object with instance ID 0.

In step S206, the NN 16 (e.g., LwM2M MS) sets to Observe the CompactData resource of the newly created Object with 10-minute report interval.

Since the NN Application 76 is also interested of the same set of values when the Minimum value changes, in step S208, NN 16 (e.g., LwM2M MS) sets a separate Observe on that resource, without any time constraint. Alternatively, this step could also use Virtual Observe (i.e., a function to notify multiple resources to a LwM2M Server in one notification message) to set the value to be reported as the CompactData; hence, removing Steps S214 and S216.

In step S210, after a predetermined time (e.g., 10 minutes) has passed (without change in the Minimum value), the WD 22 (e.g., LwM2M client) sends Notification about the current set of values, as requested in the Observe of Step S206. The NN 16 (e.g., LwM2M MS) forwards the set of data items to the application (step S212). When the Minimum value changes, the NN 16 (e.g., LwM2M MS) is notified (step S214) about the change and the NN 16 (e.g., LwM2M MS) can request the current values of all three resources using a GET of the CompactData resource (steps S216 and S218) and forward the information to the NN Application 76 (step S220).

### Discovering Existing Target Links

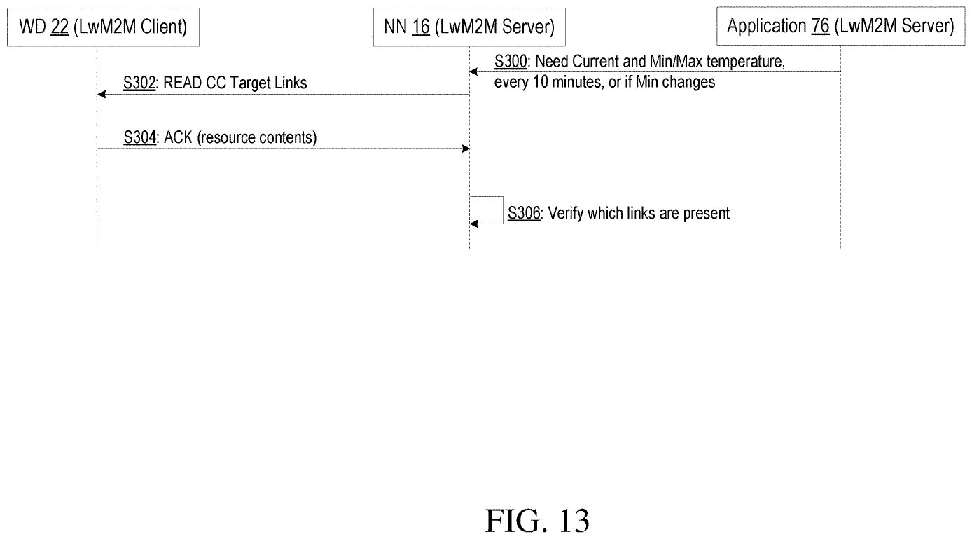

If the Compact Composite Object(s) already exists, or the CC Resources are part of another Object (see “Inline Description” section), the TargetLinks contents can be discovered from the Object as shown in FIG. 13. Step S300 may be the same as step S200 of FIG. 12, but steps S302 and S304 retrieve existing TargetLinks for NN 16 (e.g., LwM2M MS). The NN 16 (e.g., LwM2M MS) checks if any of the resulting CompactData matches to what the application requested. If any match, those are used; if not, either new CompactData are created or other LwM2M methods are used. In step S306, a verification of which links are present is performed.

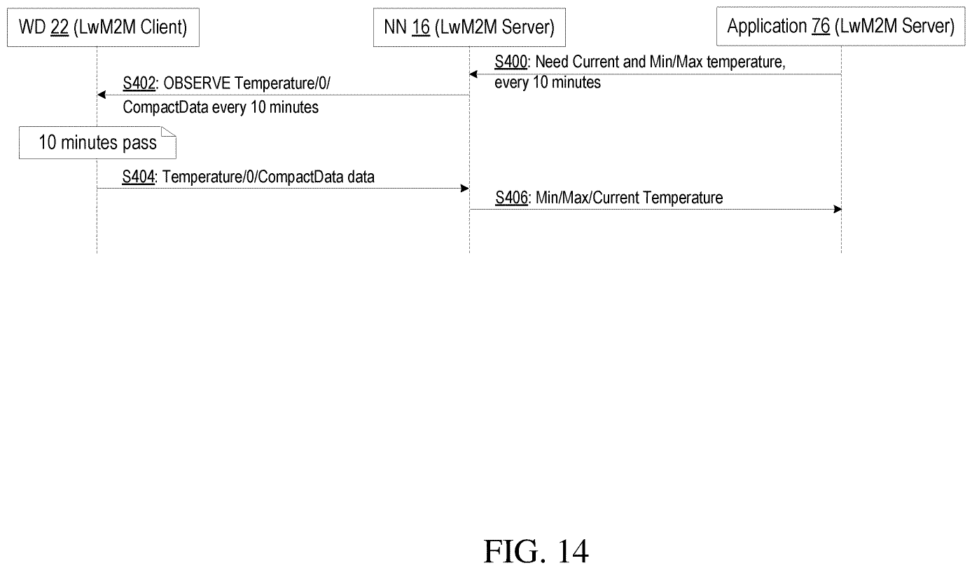

Another embodiment is described with reference to FIG. 14. In FIG. 14, step S400 may be the same as S300 of FIG. 13: NN Application 76 indicates the NN 16 (e.g., LwM2M MS) the kind of information it needs and when. Since the NN Application 76 requests a set of related information elements to be delivered at the same time, the NN 16 (e.g., LwM2M MS) uses the CompactData Resource that is contained with the Temperature Object to optimize the data transfer between the NN 16 (e.g., LwM2M MS) and the WD 22 (e.g., LwM2M client).

In step S402, the NN 16 (e.g., LwM2M MS) sets to Observe the CompactData resource of the Temperature Object with 10-minute report interval.

In step S404, after 10 minutes has passed (without change in the Minimum value), the WD 22 (e.g., LwM2M client) sends Notification about the current set of values, as requested in the Observe of S402.

The NN 16 (e.g., LwM2M MS) forwards only the set of data items requested to the NN Application 76 (step S406).

In one or more embodiments, a link is described such that a link links to an array (or map) of values (e.g., of the resource instance). In some embodiments, array of values may include an array (e.g., an existing array) of temperature values: </3303/0/5700>; type=arr, where CompactData: [val1,val2,val3, . . . ]. In some other embodiments, an array of location values may be expressed as </6/0/0>; type=arr1,</6/0/1>; type=arr2, where CompactData: [[lon1,lat1], [lon2, lat2], . . . ]. In some embodiments, the array (e.g., existing array) of temperature values may be expressed as [</3303/0/5700>], where CompactData: [val1,val2,val3, . . . ]. In some other embodiments, an array of location values may be expressed as [</6/0/0>,</6/0/1>], where CompactData: [[lon1,lat1], [lon2, lat2], . . . ]. That is, in some embodiments, a different syntax (i.e., “templates”) may be used, where square brackets in the templates indicate the presence of an array and/or CORE links indicate the values of each element.

In one or more embodiments, </3303/0/5700> is a link, where “3303” is an identifier (e.g., a standard identifier for a temperature sensor), “0” is a first temperature object instance, “5700” is a resource (e.g., resource current value), and type-arr indicates that resulting CompactData should be an array of values from all Object instances of type “3303”, starting from instance “0”. The same resulting array structure may be indicated by square brackets (e.g., instead of using “type”) when template is used. In some embodiments, </6/0/0> is used where “6” indicates a location Object identifier, which is immediately followed by “0” indicating the first location Object instance, and the subsequent “0” indicates the resource “longitude” (or resource value) and “1” resource “latitude”. The parameter “arr1” indicates that the value of resource “0” will be the first element of the resulting inner arrays and “arr2” indicates that the value of resource “1” will be the second element. All inner arrays are stored in another array, resulting in a set of nested arrays in the CompactData resource.

In an embodiment, an XML file may be used such as to describe objects, compact composites, resources, items, items identifiers, etc. A nonlimiting example of the XML file is as follows:

```
  -->
  <LWM2M xmlns:xsi=”http://www.w3.org/2001/XMLSchema-instance”
xsi:noNamespaceSchemaLocation=”http://openmobilealliance.org/tech/profiles/LWM
2M.xsd”>
    <Object ObjectType=”MODefinition”>
      <Name>Compact Composite</Name>
      <Description1>This Object enables collecting a set of Resource values
from other Objects into a single resource representation with an array of
values.</Description1>
      <ObjectID>511</ObjectID>
      <ObjectURN>urn:oma:lwm2m:ext:511</ObjectURN>
      <LWM2Mversion>1.1</LWM2Mversion>
      <ObjectVersion>1.0</ObjectVersion>
      <MultipleInstances>Multiple</MultipleInstances>
      <Mandatory>Optional</Mandatory>
      <Resources>
        <Item ID=”4020”>
          <Name>Target Links</Name>
          <Operations>RW</Operations>
          <MultipleInstances>Single</MultipleInstances>
          <Mandatory>Mandatory</Mandatory>
          <Type>Corelnk</Type>
          <RangeEnumeration/>
          <Units/>
          <Description>One or more CoRE Links to Resource instances from
which the values will be stored in the Compact Data array. Each link results in a new
item in the Compact Data array: first link points to the resource instance with the
value for the first array item, second link to the instance with the second array item,
etc. For single-instance resources the Resource instance ID can be omitted from the
link, but for multi-instance Resources it MUST be present.</Description>
        </Item>
        <Item ID=”4021”>
          <Name>Compact Data</Name>
          <Operations>RW</Operations>
          <MultipleInstances>Single</MultipleInstances>
          <Mandatory>Mandatory</Mandatory>
          <Type>Opaque</Type>
          <RangeEnumeration/>
          <Units/>
          <Description>CBOR array of resource values in the same order as
the links in the Target Links resource or empty value if there is error (e.g., link
pointing to a resource that doesn't exist).</Description>
        </Item>
        <Item ID=”4023”>
          <Name>Description</Name>
          <Operations>RW</Operations>
          <MultipleInstances>Single</MultipleInstances>
          <Mandatory>Optional</Mandatory>
          <Type>String</Type>
          <RangeEnumeration/>
          <Units/>
          <Description>Human-readable description of the Compact Data
resulting from the Target Links.</Description>
        </Item>
      </Resources>
    </Object>
  </LWM2M>
```

In some embodiments, Resource IDs may comprise “0”, “1”, and “2” (e.g., instead of 4020, 4021, and 4023), which may be object specific resources instead of re-usable resources. In some other embodiments, resource IDs are reusable.

The following is a nonlimiting list of example embodiments:

Embodiment A1. A network node 16 configured to communicate with a wireless device (WD) 22, the network node 16 configured to, and/or comprising a radio interface and/or comprising processing circuitry configured to:
determine a compact composite (CC) object associated with a resource model, the determined CC object to be implemented by the WD 22 and comprising at least one of a structure description resource and a compact structure resource; and
perform at least one action to collect information associated with at least one of the CC object, the structure description resource, and the compact structure resource.

Embodiment A2. The network node of Embodiment A1, wherein the CC object includes a link to one or more resources including the at least one of the structure description resource and the compact structure resource.

Embodiment A3. The network node of Embodiment A2, wherein the determination of the CC object includes at least one of:
creating the CC object, the creation of the CC object including transmission of a first request to create the CC object that triggers the WD 22 to implement the CC object, the set of resources being accessible to the network node;
discovering the created CC object at least by sending a second request to read the link of the CC object; and
examining the link of the CC object to determine a structure of the compact structure resource and perform the at least one action to collect the information based on the determined structure.

Embodiment A4. The network node of Embodiments A1-A3, wherein at least one of:
the resource model is a lightweight machine to machine (LwM2M) object resource model;
the CC object is a CC LwM2M object;
the network node is an LwM2M management server; and
the WD 22 is an LwM2M client.

Embodiment B1. A method implemented in a network node 16 configured to communicate with a wireless device (WD) 22, the method comprising:
determining a compact composite (CC) object associated with a resource model, the determined CC object to be implemented by the WD 22 and comprising at least one of a structure description resource and a compact structure resource; and
performing at least one action to collect information associated with at least one of the CC object, the structure description resource, and the compact structure resource.

Embodiment B2. The method of Embodiment B1, wherein the CC object includes a link to one or more resources including the at least one of the structure description resource and the compact structure resource.

Embodiment B3. The method of Embodiment B2, wherein the determination of the CC object includes at least one of:
creating the CC object, the creation of the CC object including transmission of a first request to create the CC object that triggers the WD 22 to implement the CC object, the set of resources being accessible to the network node 16;
discovering the created CC object at least by transmitting a second request to read the link of the CC object; and
examining the link of the CC object to determine a structure of the compact structure resource and perform the at least one action to collect the information based on the determined structure.

Embodiment B4. The method of Embodiments B1-B3, wherein at least one of:
the resource model is a lightweight machine to machine (LwM2M) object resource model;
the CC object is a CC LwM2M object;
the network node 16 is an LwM2M management server; and
the WD 22 is an LwM2M client.

Embodiment C1. A wireless device (WD) 22 configured to communicate with a network node 16, the WD 22 configured to, and/or comprising a radio interface and/or processing circuitry configured to:
determine a compact composite (CC) object associated with a resource model, the determined CC object to be implemented by the WD 22 and comprising at least one of a structure description resource and a compact structure resource; and
perform at least one action to provide information associated with at least one of the CC object, the structure description resource, and the compact structure resource.

Embodiment C2. The WD 22 of Embodiment C1, wherein the CC object includes a link to one or more resources including the at least one of the structure description resource and the compact structure resource.

Embodiment C3. The WD 22 of Embodiment C2, wherein the determination of the CC object includes at least one of:
creating the CC object for a set of resources, the created CC object being implemented by the WD 22 based on a first request by the network node 16, the set of resources being accessible to the network node 16; and
receiving a second request to read the link of the CC object, the received request allowing the network node 16 to discover the created CC object, the discovering of the created object being usable by the network node 16 to examine the link of the CC object to determine a structure of the compact structure resource and perform the at least one action to collect the information.

Embodiment C4. The WD 22 of Embodiment C1-C3, wherein at least one of:
the resource model is a lightweight machine to machine (LwM2M) object resource model;
the CC object is a CC LwM2M object;
the network node 16 is an LwM2M management server; and
the WD 22 is an LwM2M client.

Embodiment D1. A method implemented in a wireless device (WD) 22 configured to communicate with a network node 16, the method comprising:
determining a compact composite (CC) object associated with a resource model, the determined CC object to be implemented by the WD 22 and comprising at least one of a structure description resource and a compact structure resource; and
performing at least one action to provide information associated with at least one of the CC object, the structure description resource, and the compact structure resource.

Embodiment D2. The method of Embodiment D1, wherein the CC object includes a link to one or more resources including the at least one of the structure description resource and the compact structure resource.

Embodiment D3. The method of Embodiment D2, wherein the determination of the CC object includes at least one of:
creating the CC object for a set of resources, the created CC object being implemented by the WD 22 based on a first request by the network node 16, the set of resources being accessible to the network node 16; and
receiving a second request to read the link of the CC object, the received request allowing the network node 16 to discover the created CC object, the discovering of the created object being usable by the network node 16 to examine the link of the CC object to determine a structure of the compact structure resource and perform the at least one action to collect the information.

Embodiment D4. The method of Embodiment D1-D3, wherein at least one of:
the resource model is a lightweight machine to machine (LwM2M) object resource model;
the CC object is a CC LwM2M object;
the network node 16 is an LwM2M management server; and
the WD 22 is an LwM2M client.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, using at least one of a wired connection and a wireless connection, the network node comprising processing circuitry configured to:
determine a compact composite, CC, object associated with a resource model, the determined CC object to be implemented by the WD and comprising a structure description resource, the structure description resource comprising one or more links to one or more resources accessible by the network node; and
perform at least one action to collect information associated with at least one of the CC object and the structure description resource.

2.-10. (canceled)

11. A method in a network node configured to communicate with a wireless device, WD, using at least one of a wired connection and a wireless connection, the method comprising:
determining a compact composite, CC, object associated with a resource model, the determined CC object to be implemented by the WD and comprising a structure description resource, the structure description resource comprising one or more links to one or more resources accessible by the network node; and
performing at least one action to collect information associated with at least one of the CC object and the structure description resource.

12. The method of claim 11, wherein the determination of the CC object includes:
creating the CC object, the creation of the CC object including transmission of a first request to create the CC object that triggers the WD to implement the CC object.

13. The method of claim 11, wherein the determination of the CC object includes:
discovering the CC object at least by sending a second request to read the one or more links.

14. The method of claim 11, wherein the CC object further comprises the compact data resource, and wherein the determination of the CC object includes:
examining the one or more links to determine a structure of the compact data resource and to perform the at least one action to collect the information based on the determined structure.

15. (canceled)

16. The method of claim 11, wherein the CC object is pre-instantiated in the WD.

17. The method of claim 11, wherein the method further includes:
at least one of:
receiving a data request from a software application to provide data associated with one CC object; and
receiving a CC object identifier from the WD; and
determining the CC object based on at least one of the received data request and the received CC object identifier.

18. The method of claim 11, wherein the CC object further comprises the compact data resource, and wherein the method further includes:
transmitting a fourth request to one of create and update the compact data resource using a composite read operation, the fourth request including an indication indicating whether the compact data resource is to be created or updated.

19. The method of claim 11, wherein the CC object further comprises the compact data resource and wherein the one or more links points to at least one of an array of the data values and a map of the data values.

20. The method of claim 11, wherein at least one of:
the information includes the one or more data values associated with the one or more resources;
the resource model is a lightweight machine to machine, LwM2M, object resource model;
the CC object is a CC LwM2M object;
the network node is an LwM2M management server; and
the WD is an LwM2M client.

21. A wireless device, WD, configured to communicate with a network node using at least one of a wired connection and a wireless connection, the WD comprising processing circuitry configured to:
determine a compact composite, CC, object associated with a resource model, the determined CC object to be implemented by the WD and comprising a structure description resource, the structure description resource comprising one or more links to one or more resources accessible by the network node; and
perform at least one action to provide information associated with at least one of the CC object and the structure description resource.

22.-30. (canceled)

31. A method in a wireless device, WD, configured to communicate with a network node using at least one of a wired connection and a wireless connection, the method comprising:
determining a compact composite, CC, object associated with a resource model, the determined CC object to be implemented by the WD and comprising a structure description resource, the structure description resource comprising one or more links to one or more resources accessible by the network node; and
performing at least one action to provide information associated with at least one of the CC object and the structure description resource.

32. The method of claim 31, wherein the determination of the CC object includes:
creating the CC object based on a first request received form the network node.

33. The method of claim 31, wherein the determination of the CC object includes:
making the CC object discoverable by the network node based on a second request, received from the network node, to read the one or more links.

34. The method of claim 31, wherein the CC object further comprises the compact data resource and wherein the provided information triggers the network node to examine the one or more links to determine a structure of the compact data resource.

35. (canceled)

36. The method of claim 31, wherein the CC object is pre-instantiated in the WD.

37. The WD of claim 31, wherein the method further includes:
transmitting a CC object identifier usable by the network node to determine the CC object.

38. (canceled)

39. The method of claim 31, wherein the one or more links points to at least one of an array of the data values and a map of the data values.

40. (canceled)

41. The method of claim 11, wherein the CC object further comprises a compact data resource including one or more data values associated with the one or more resources, and wherein performing at least one action to collect information comprises:
performing at least one action to collect information associated with at least one of the CC object, the structure description resource and the compact data resource.

42. The method of claim 31, wherein the CC object further comprises a compact data resource including one or more data values associated with the one or more resources; and wherein performing at least one action to collect information comprises:
performing at least one action to collect information associated with at least one of the CC object, the structure description resource and the compact data resource.
